(19) United States
(12) Patent Application Publication
(10) Pub. No.: US 2026/0358054 A1
(43) Pub. Date: Nov. 12, 2026

(54) METHOD FOR THE SHAFT REVERSAL IN A PARALLEL-FLOW REGENERATIVE SHAFT FURNACE

(71) Applicants: Maerz Ofenbau AG, Zurich (CH); thyssenkrupp AG, Essen (DE)

(72) Inventors: Yves ASCHWANDEN, Zurich (CH); Patrick BUCHER, Schoenenwerd (CH)

(73) Assignees: Maerz Ofenbau AG, Zurich (CH); thyssenkrupp AG, Essen (DE)

(21) Appl. No.: 19/119,550

(22) PCT Filed: Sep. 26, 2023
(86) PCT No.: PCT/EP2023/076479

§ 371 Date: Apr. 9, 2025

(30) Foreign Application Priority Data
Oct. 14, 2022 (DE) 10 2022 210 898.1
Oct. 14, 2022 (LU) LU 103028

(51) Int. Cl. F27B 1/02; F27B 1/22; F27B 1/26; F27D 17/13

(52) U.S. Cl. CPC F27B 1/02; F27B 1/22; F27B 1/26; F27D 17/13

(57) ABSTRACT

A method for shaft switchover in a parallel flow regenerative shaft kiln comprises: a) operating the first shaft as a burning shaft and the second shaft as a regenerative shaft, b) stopping the fuel supply through the first fuel feed and thus carrying out burnout in the first shaft, c) closing the second exhaust gas outlet, after the start of step c and before the end of step c, starting the following steps d to f, d) opening the second combustion gas inlet, e) closing the first combustion gas inlet, f) opening the first exhaust gas outlet, and g) starting the fuel supply through the second fuel feed and thus operating the second shaft as a burning shaft and the first shaft as a regenerative shaft.

The invention relates to a method for shaft switchover in a parallel flow regenerative shaft kiln (PFR shaft kiln) in order to avoid mixing between the kiln exhaust gas and the lime cooling air. This allows the carbon dioxide concentration in the kiln exhaust gas to be kept at a high level and thus allows simplified removal.

Burning of carbonate rock in a PFR shaft kiln has been known for about 60 years. A PFR shaft kiln of this kind which is known for example from WO 2011/072894 A1 has two vertical, parallel shafts which operate in cycles, with burning being performed only in one shaft, which becomes the burning shaft, while the other shaft operates as a regenerative shaft. The burning shaft is supplied with oxidation gas in parallel flow with the material and fuel, and the resultant hot exhaust gases, together with the heated cooling air which is supplied from below, are conducted via the crossover channel into the exhaust gas shaft, where the exhaust gases are conducted away upward in countercurrent to the material and preheat the material in the process. The material is usually fed into the shaft from above together with the oxidation gas, with fuels being injected in the burning zone.

In each shaft, the material to be burned usually passes through a preheating zone for preheating the material, a subsequent burning zone in which the material is burned, and a subsequent cooling zone in which cooling air is supplied to the hot material.

In order to meet the quality requirements with respect to high reactivity of the burnt lime, as required for example in steelworks, the temperatures in the burning zone must not exceed a value of 1100 °C, preferably 1000 °C. Furthermore, the demand for environmentally friendly production of burnt lime is also increasing, and so certain requirements for the CO₂ content of the exhaust gas for subsequent aftertreatment must be met.

Parallel flow regenerative shaft kilns were therefore developed in order to generate an exhaust gas with as high a content of carbon dioxide as possible and thus minimize the effort of removal. DE 10 2021 204 176 discloses such a parallel flow regenerative shaft kiln and a method for burning carbonate rock. The parallel flow regenerative shaft kiln (PFR shaft kiln) is used for burning and cooling material, such as carbonate rocks. The PFR shaft kiln comprises having two shafts which are operated alternately as a burning shaft and as a regenerative shaft and are connected to one another by means of a connecting channel. Each shaft has, in the direction of flow of the material, a preheating zone for preheating the material, a burning zone for burning the material and a cooling zone for cooling the material. Each shaft also has an exhaust gas outlet for discharging exhaust gas from the shaft. The at least one exhaust gas outlet is connected to a gas inlet for admitting gas into at least one shaft. Preferably, the PFR shaft kiln has a multiplicity of gas inlets for admitting exhaust gas extracted from at least one of the shafts.

During operation, mixing between the kiln exhaust gas and the lime cooling air was found to occur during shaft switchover, which causes temporary lowering of the carbon dioxide content in the exhaust gas.

RU 2 724 835 C1 discloses a method for calcinating carbonate material in a countercurrent kiln having two shafts.

DE 10 2004 002 043 A1 discloses a method for burning granular, combustible mineral material.

For example, DE 10 2021 204 176 A1 discloses a parallel flow regenerative shaft kiln and a method for burning carbonate rock.

It is an object of the invention to provide a method for shaft switchover, in which mixing between the kiln exhaust gas and the lime cooling air is substantially avoided in order to thus avoid lowering of the carbon dioxide content in the exhaust gas and thus allow carbon dioxide removal in a simple manner.

This object is achieved by the method having the features specified in claim 1 and by the control system having the features specified in claim 19. Advantageous developments will be apparent from the subclaims, the description that follows and the drawings.

The method according to the method is used for shaft switchover in a parallel flow regenerative shaft kiln. In a parallel flow regenerative shaft kiln (PFR shaft kiln), initially one shaft is used as a combustion shaft and the second shaft as a regenerative shaft.

After one cycle, which can last for example between 10 min and 60 min, in particular between 10 min and 20 min, for example 15 min, a shaft switchover takes place and the first shaft is then used as a regenerative shaft and the second shaft as a burning shaft. Here, with conventional plants, the PFR shaft kiln was normally switched under depressurized conditions, the burned product removed at the bottom and the product to be burned fed from the top. The advantage of the PFR shaft kiln is that this reciprocal operation results in very efficient heat recovery and that the process is thus very energy-efficient. According to the invention, a radical departure is made from this prior method for shaft switchover. Instead, a certain gas flow and thus pressure in the PFR shaft kiln is maintained, as a result of which the exhaust gas continues to be of constantly high carbon dioxide concentration even during shaft switchover, such that removal, in particular subsequent liquefaction, remains easily possible.

The parallel flow regenerative shaft kiln which is used for the method according to the invention has a first shaft and a second shaft. The first shaft has a first preheating zone for preheating the material, a first burning zone for burning the material and a first cooling zone for cooling the material. The second shaft has a second preheating zone for preheating the material, a second burning zone for burning the material and a second cooling zone for cooling the material. The first burning zone and the second burning zone are connected via a connecting channel. The first preheating zone has a first combustion gas inlet and the second preheating zone has a second combustion gas inlet. The first preheating zone has a first exhaust gas outlet and the second preheating zone has a second exhaust gas outlet. The first burning zone has at least one first burning lance and the second burning zone has at least one second burning lance. The at least one first burning lance is connected to a first fuel feed and the at least one second burning lance is connected to a second fuel feed.

The method comprises the following steps:
a) operating the first shaft as a burning shaft and the second shaft as a regenerative shaft,
b) stopping the fuel supply through the first fuel feed and thus carrying out burnout in the first shaft,
c) closing the second exhaust gas outlet, after the start of step c) and before the end of step c), starting the following steps d) to f)
d) opening the second combustion gas inlet,
e) closing the first combustion gas inlet,
f) opening the first exhaust gas outlet,
g) starting the fuel supply through the second fuel feed and thus operating the second shaft as a burning shaft and the first shaft as a regenerative shaft.

It is therefore essential that the supply of combustion gas and the discharge of exhaust gas is never interrupted at any time. The PFR shaft kiln thus does not become depressurized, i.e., it is not brought to ambient pressure. This in turn results in minimization of mixing between the exhaust gas and the cooling gas even during shaft switchover. In particular, it is possible to convey the cooling gas in unaltered form through the PFR shaft kiln; in particular, there is precisely no need to stop or alter the supply of cooling gas. As a result, it remains very simple to remove carbon dioxide from the exhaust gas, since the concentration of carbon dioxide remains constantly high.
Step a) corresponds to the normal burning process. Step b) also corresponds to the normal procedure.
Step c) first starts with the closing of the second exhaust gas outlet. This in turn means that there is precisely no opening of the PFR shaft kiln, i.e., it is not brought to ambient pressure, and that pressure is maintained instead. During the closing, what then start, with temporal overlap, are the opening of the second combustion gas inlet in step d), the closing of the first combustion gas inlet in step e) and the opening of the first exhaust gas outlet in step f). The effect is that the pressure in the connecting channel can be kept comparatively constant, which in turn is a good indicator that mixing with the cooling gas is avoided.

Whereas it was hitherto customary to depressurize the PFR shaft kiln during switching while, at the same time, removing finished product at the bottom and feeding new reactant from the top, the kiln being at ambient pressure anyhow, this is not the case with the method according to the invention. Here, especially the removal of product and the feeding of reactant can also be carried out, for example, by way of locks independently of the switching process. Therefore, it is precisely not necessary for the method according to the invention to be directly linked to reactant feeding and/or product removal; instead, it can be carried out separately therefrom.

In a further embodiment of the invention, steps d) and e) are carried out synchronously. For example and preferably, this may be done by way of a switchable Y-switch. The gas flow that flows to the combustion gas inlets is not interrupted; instead, said gas flow is supplied to the combustion gas inlet to be opened to exactly the extent that the combustion gas inlet to be closed is closed. As a result, the amount of gas flowing to the PFR shaft kiln can be kept constant over the switching process in a very simple manner. However, since steps c) and f) precisely do not proceed synchronously, but with a temporal offset, there is thus in fact a reduced gas discharge at a constant gas supply, meaning that the pressure inside the PFR shaft kiln is more likely to rise and thus, for example, no cooling gas can come out of the cooling zones.

In a further embodiment of the invention, steps d) to f) start at the same time. This is preferred and ensures a particularly constant pressure in the connecting channel.

In a further embodiment of the invention, steps c), d) and e) have a first length of time t₁. Step f) has a second length of time t₂, the second length of time t₂ being longer than the first length of time t₁. This means that the opening of the first exhaust gas outlet in step f) takes place more slowly. Especially in conjunction with the earlier start of the closing of the second exhaust gas outlet in step c), this ensures that the PFR shaft kiln does not become depressurized and that, instead, the pressure conditions, especially in the burning zones, remain sufficiently stable for mixing with the cooling gases to be avoided particularly reliably.

In a further embodiment of the invention, the second length of time t₂ is 1.5 to 5 times as long as the first length of time t₁. Preferably, the second length of time t₂ is 2 to 3 times as long as the first length of time t₁.

In a further embodiment of the invention, step f) starts after the start and before the end of steps c), d) and e). Thus, although the gas discharge via the first exhaust gas outlet and the second exhaust gas outlet is permanently opened, the gas discharge is initially reduced in the course of the method, thereby ensuring that the pressure inside the PFR shaft kiln is more likely to rise rather than fall in a simple manner, thus reliably preventing mixing with cooling air.

In a further embodiment of the invention, step c) has a first length of time t₁. Steps d), e) and f) start ¼ t₁ to ¾ t₁, in particular ⅓ t₁ to ⅔ t₁, after the start of step c). For example, steps d), e) and f) start exactly in the middle of step c), i.e., with a time offset of ½ t₁.

In a further embodiment of the invention, the supply of cooling gas and the discharge of cooling gas in the first cooling zone and in the second cooling zone is continued continuously at a constant flow of cooling gas. Here, in particular, the gas flow is kept constant across all the steps. This allows the flow profile and pressure profile in the first cooling zone and in the second cooling zone to be kept constant.

In a further embodiment of the invention, the opening and closing in steps c), d), e) and f) is carried out at variable speed. In particular, the opening is initially carried out relatively slowly and is then quickened as the steps progress. In particular, the closing is initially carried out relatively rapidly and then becomes slower as the steps progress.

In a further embodiment of the invention, a first pressure is measured in the upper gas region of the first shaft. Furthermore, a second pressure is measured in the upper gas region of the second shaft. Optionally, the pressure in the connecting channel may be additionally measured. The measurement of the pressure allows control according to the pressures measured.

In a further embodiment of the invention, the speed of opening and closing in steps c), d), e) and f) is controlled such that the first pressure falls at a constant first rate and/or the second pressure rises at a constant second rate. If control is carried out only with respect to one pressure, preference is given to control with respect to the falling pressure. As a result of this, only a minimal pressure drop in the connecting channel is detectable, meaning that mixing with the cooling gas can be substantially avoided.

In a further embodiment of the invention, the first rate is identical in terms of absolute value to the second rate. The first rate and the second rate have opposite signs. “Identical in terms of absolute value” is to be understood here in the technical sense and not in the exactly mathematical sense. This achieves synchronous switching of the gas flow in the first shaft and in the second shaft of the PFR shaft kiln.

In a further embodiment of the invention, the first combustion gas inlet and the second combustion gas inlet are connected to a combustion gas line. The combustion gas line is connected to an oxidizing agent supply. In particular, the oxidizing agent supply may be connected to an air separation or to some other source of oxygen. Preferably, oxygen having a purity of at least 90%, preferably at least 95%, more preferably at least 98% is supplied via the oxidizing agent supply. The oxidizing agent supply is opened after completion of steps c), d), e) and f) and before the start of step g).

In a further embodiment of the invention, the oxidizing agent supply is closed during step b). Preference is given to a procedure such that the closing of the oxidizing agent supply has been completed when step b) is ended.

In a further embodiment of the invention, a rising opening speed is selected for the opening speed in steps d) and f).

In a further embodiment of the invention, the feeding of reactant and the removal of product are carried out during step a). Feeding and removal are therefore carried out via a lock so that neither the gas composition nor the pressure inside the PFR shaft kiln is adversely affected.

In a further embodiment of the invention, the opening position of the first combustion gas inlet, the second combustion gas inlet, the first exhaust gas outlet and the second exhaust gas outlet is detected. This also specifically allows active control of the speed of opening and closing.

Furthermore, in the PFR shaft kiln for carrying out the method, the gas inlet may be arranged in the preheating zone of the shaft operated as a burning shaft. The gas inlet in the preheating zone of the burning shaft is preferably a combustion gas inlet, via which an oxidizing agent is preferably introduced into the preheating zone in addition to the exhaust gas. The gas inlet is preferably arranged at the upper end of the preheating zone.

Furthermore, in the PFR shaft kiln for carrying out the method, the gas inlet may be arranged in the connecting channel for gas connection of the burning zones of the shafts and/or arranged in the burning zone of the shaft, in particular of the regenerative shaft, and/or in a material-free space in the shaft. In particular, the material-free space is in the form of an external annular space which extends circumferentially around preferably the upper region of the cooling zone adjacent to the burning zone.

Furthermore, in the PFR shaft kiln for carrying out the method, arranged between the exhaust gas outlet and the gas inlet in the connecting channel for gas connection of the burning zones of the shafts and/or in the burning zone may be a heat exchanger and/or a heating device, in particular an electrical heating device, a solar device or a combustion reactor, for heating the exhaust gas. For example, the heat exchanger is arranged upstream of the heating device in the direction of flow of the exhaust gas. It is also conceivable that there is only a heat exchanger or a heating device for heating the exhaust gas.

Furthermore, in the PFR shaft kiln for carrying out the method, the cooling zone may have a cooling gas inlet for admitting cooling gas into the cooling zone and a cooling gas extraction device for discharging cooling gas from the shaft.

Furthermore, in the PFR shaft kiln for carrying out the method, may have a material-free space within the cooling zone of the shaft. In particular, the material-free space is in the form of an external annular space which extends circumferentially around preferably the upper region of the cooling zone adjacent to the burning zone. In particular, the cooling gas outlet is arranged in the material-free annular space.

The material-free space of the cooling gas extraction device is in the form for example of an inner cylinder which extends in particular centrally and in the vertical direction through the cooling zone. In particular, the inner cylinder extends at least partially into the burning zone. The cooling gas outlet for discharging the cooling gas from the shaft is arranged in the inner cylinder. The inner cylinder preferably has a cooling gas inlet for admitting cooling gas of the cooling zones into the interior of the inner cylinder, the cooling gas inlet being preferably arranged below the cooling gas outlet in the inner cylinder. In particular, the cooling gas inlet is arranged at the lower end of the cooling zone, so that the cooling gas preferably flows through the entire cooling gas zone and then into the inner cylinder of the cooling gas extraction device. Inside the inner cylinder, the cooling gas preferably flows downward in the direction of the cooling gas outlet and into the cooling gas extraction line. A cooling gas extraction device in the form of an inner cylinder enables a low structural height of the cooling zone and comparatively easy retrofitting of known PFR shaft kilns.

The material-free space of the cooling gas extraction device is in the form for example of a connecting channel for gas connection of the cooling zones of the two shafts, the cooling gas outlet being preferably arranged in the connecting channel, in particular centrally.

The cooling gas extraction device is preferably configured such that it discharges all of the cooling gas from the shaft so that preferably no cooling gas passes into the burning zone or the connecting channel for connecting the burning zones of the shafts. In particular, the cooling gas extraction device is connected to a control element, such as a flap or a valve, in order to adjust the amount of cooling gas to be extracted.

Furthermore, in the PFR shaft kiln for carrying out the method, the cooling gas extraction device may be connected to a heat exchanger for heating the exhaust gas. The cooling gas extraction device is connected to the heat exchanger in particular by means of the cooling gas extraction line. The heat exchanger preferably serves to heat the exhaust gas that was discharged from the preheating zone of the regenerative shaft via the exhaust gas outlet. The heat exchanger is in particular connected to the exhaust gas outlet and the cooling gas outlet of the cooling gas extraction device.

Furthermore, in the PFR shaft kiln for carrying out the method, each shaft may have a combustion gas inlet for admitting combustion gas into the preheating zone and/or the burning zone, the combustion gas inlet being connected to an oxidizing agent line for conducting an oxidizing agent into the shaft. The combustion gas inlet is preferably connected to the exhaust gas outlet for conducting the exhaust gas into the shaft.

In a further aspect, the invention relates to a control system for a parallel flow regenerative shaft kiln that is designed to execute the method according to the invention. Preferably, the control system has for this purpose executable program instructions for executing the method according to the invention. The control system is thus not only suitable for, but also capable of, executing the method according to the invention.

The method according to the invention is explained in more detail below on the basis of an exemplary embodiment shown in the drawings.

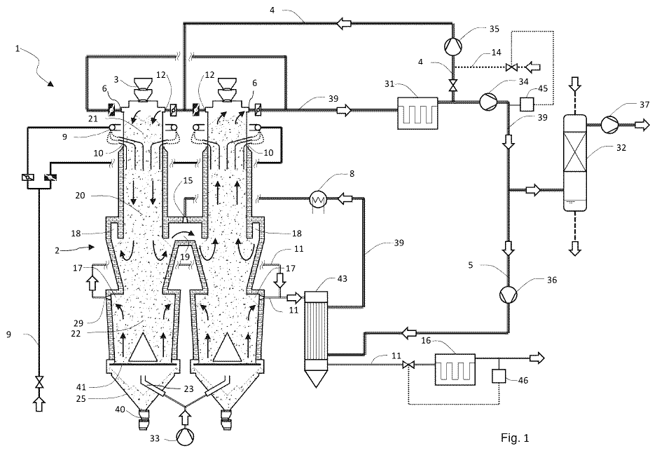

FIG. 1 first exemplary PFR shaft kiln for carrying out the method

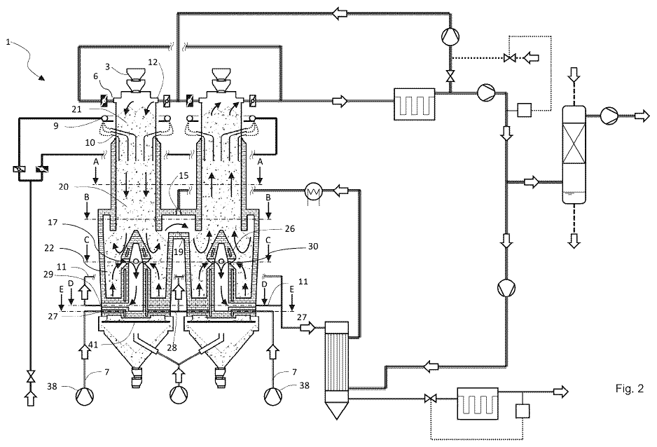

FIG. 2 second exemplary PFR shaft kiln for carrying out the method

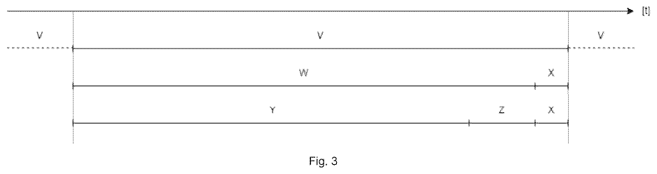

FIG. 3 complete cycle

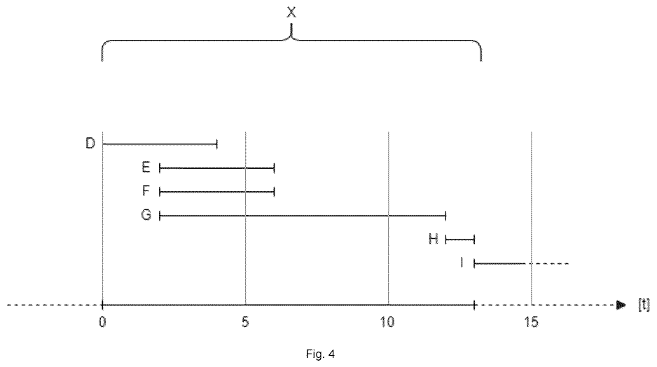

FIG. 4 shaft switchover

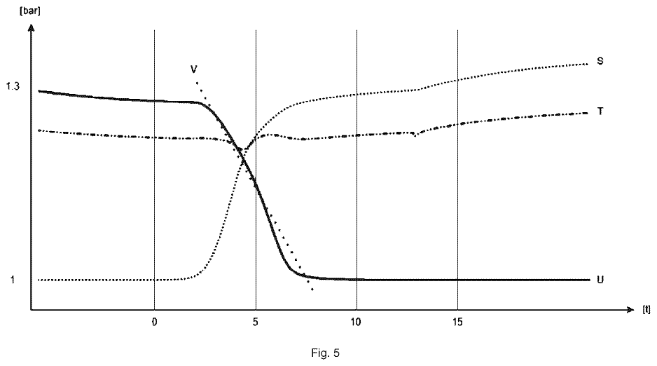

FIG. 5 pressure curve during shaft switchover

In the figures and the reference signs, no distinction is made between the first shaft and the second shaft. With each cycle, the functions are swapped between the two shafts, and so a common reference sign for the first shaft and the second shaft and the corresponding components is appropriate.

FIG. 1 shows a PFR shaft kiln 1 having two parallel and vertically oriented shafts 2. The shafts 2 of the PFR shaft kiln 1 are of substantially identical construction, and so only one of the two shafts 2 is provided with reference signs in FIG. 1 and only one of the two shafts 2 is described below for the sake of simplicity. Each shaft 2 has a respective material inlet 3 for admitting material to be burned into the respective shaft 2 of the PFR shaft kiln 1. The material to be burned is in particular limestone and/or dolomite rock preferably having a grain size of 10 to 200 mm, preferably of 15 to 120 mm, most preferably 30 to 100 mm. By way of example, the material inlets 3 are arranged at the upper end of the respective shaft 2 so that the material falls through the material inlet 3 into the shaft 2 due to gravity. The material inlet 3 is for example in the form of an upper opening in the shaft 2 and in particular in the form of a lock 3 and preferably extends over the entirety or a portion of the cross section of the shaft 2. A material inlet in the form of a lock 3 is preferably designed such that only the raw material to be burned passes into the shaft 2, but not the ambient air. The lock 3 is preferably configured such that it seals off the shaft 2 against the environment in an airtight manner and allows solids, such as the material to be burned, to enter the shaft.

Each shaft 2 also has, at its upper end, a combustion gas inlet 12 for admitting combustion gas for the combustion of fuels. The combustion gas is for example dedusted exhaust gas from at least one of the shafts 2, with the exhaust gas preferably being enriched with oxygen. Furthermore, each shaft 2 has an exhaust gas outlet 6 for discharging exhaust gases from the respective shaft 2. By way of example, a respective control element is assigned to each exhaust gas outlet 6 and combustion gas inlet 12. The control elements, such as an adjustable-volume compressor 35, can preferably be used to adjust the amount of combustion gas in the respective combustion gas inlet 12 and the amount of exhaust gas to be extracted via the respective exhaust gas outlet 6. The combustion gas inlet 12 and the exhaust gas outlet are arranged by way of example at the same height level and in particular inside the preheating zone 21 of the respective shaft 2.

Arranged at the lower end of the shaft 2 is a material outlet 40 for discharging the burned material. The material outlet 40 is for example a lock as described with reference to the material inlet 3.

The burned material is conducted for example into an outlet funnel 25, which is adjoined by the material outlet 40 of the shaft 2. By way of example, the outlet funnel 25 is funnel-shaped. The outlet funnel 25 preferably has a cooling gas inlet 23 for admitting cooling gas into the respective shaft 2. The cooling gas is preferably conducted into the cooling gas inlet by means of a compressor 33.

During operation of the PFR shaft kiln 1, the material to be burned flows from the top to the bottom through the respective shaft 2, while the cooling air flows from the bottom to the top, in countercurrent to the material, through the respective shaft 2. The kiln exhaust gas is discharged from the shaft 2 through the exhaust gas outlet 6.

The preheating zone 21 of the respective shaft 2 adjoins in the direction of flow of the material below the material inlet 3 and the combustion gas inlet 12. The material and the combustion gas are preferably preheated to about 700 °C in the preheating zone 21. The respective shaft 2 is preferably filled with material to be burned. The material is preferably fed into the respective shaft 2 above the preheating zone 21. At least part of the preheating zone 21 and that part of the respective shaft 2 which adjoins it in the direction of flow of the material are surrounded with a refractory lining, for example.

A multiplicity of burner lances 10 are optionally arranged in the preheating zone 21 and each serve as an inlet for fuel, such as fuel gas, oil or ground solid fuel. The PFR shaft kiln 1 has for example a cooling device for cooling the burner lances 10. The cooling device comprises for example a multiplicity of cooling air ring lines which extend annularly around the shaft region in which the burner lances 10 are arranged. Cooling air for cooling the burner lances 10 preferably flows through the cooling air ring lines. Preferably, the burner lances 10 are cooled by means of the exhaust gas discharged via the exhaust gas outlet 6. The exhaust gas outlet 6 is preferably connected to the burner lances 10 for conducting exhaust gas to the burner lances 10.

A multiplicity, for example twelve or more, of burner lances 10 are preferably arranged in each shaft 2 at a substantially uniform distance from one another. By way of example, the burner lances 10 have an L shape and preferably extend in a horizontal direction into the respective shaft 2 and in a vertical direction, in particular in the direction of flow of the material, inside the shaft 2. The ends of the burner lances 10 of a shaft 2 are preferably all arranged at the same height level. Preferably, the plane on which the lance ends are arranged is in each case the lower end of the respective preheating zone 21. The burner lances 10 are preferably connected to a fuel line 9 for conducting fuel to the burner lances 10. By way of example, the fuel line 9 is at least partially in the form of a ring line which extends circumferentially around the respective shaft 2. Preferably, each shaft 2 has a fuel line which is assigned in each case to the burner lances 10 of the shaft 2 and which in particular has a respective control element for adjusting the amount of fuel to the burner lances 10.

The burning zone 20 adjoins the preheating zone 21 in the direction of flow of the material. In the burning zone 20, the fuel is combusted and the preheated material is burned at a temperature of about 1000 °C. The PFR shaft kiln 1 furthermore has a connecting channel 19 for gas connection of the two shafts 2 to one another. There is in particular no material to be burned in the connecting channel 19.

By way of example, FIG. 1 shows a PFR lime kiln 1 with round shaft cross sections. However, the shaft cross section can have a different geometric contour, such as round, semicircular, oval, square or polygonal. The burner zone 20 extends by way of example in a first and a second shaft section, where the first shaft section has a cross section that is substantially constant or becomes slightly larger toward the bottom. The first shaft section is adjoined in the direction of flow of the material by a second shaft section which has a shaft cross section that decreases in the direction of flow of the material.

The lower region of the first shaft section extends into the upper region of the second shaft section, with the result that an annular channel 18 is formed between the two shaft sections. The annular channel 18 forms a material-free space in which no material to be burned is arranged. The upper region of the second shaft section has a larger cross section than the first shaft section, with the cross section of the second shaft section reducing to the cross section of the first shaft section in the direction of flow of the material and preferably forming the lower end of the burning zone 20. The annular channel 18 preferably extends circumferentially around the lower region of the first shaft section of the burning zone 20. For example, each of the shafts 2 of FIG. 1 have an annular channel 18, the latter being connected to the connecting channel 19.

The burning zone 20 is adjoined in the direction of flow of the material in each shaft 2 by a cooling zone 22 which extends as far as the material outlet 40. The cooling zone is formed in a shaft section with a cross section that is substantially constant or becomes smaller toward the bottom. The cross section of the shaft section of the cooling zone 22 is larger than the cross section of the lower region of the burning zone 20, with the result that a further material-free space 17, in particular an annular shoulder, in which no material is arranged, is formed at the upper end of the cooling zone 22 and adjacent to the burning zone 20. The material is cooled inside the cooling zone 22 to about 100 °C in countercurrent to the cooling gas flowing through the material. Arranged at the lower end of the cooling zone 22 is a preferably conical flow device which serves to conduct the material in the direction of the shaft wall.

Each cooling zone 22 has a respective cooling air outlet device 17 having a respective cooling gas outlet 29. In the exemplary embodiment of FIG. 1, the cooling air outlet device 17 is in the form of a material-free, in particular annular, space 17. The cooling gas outlet 29 is preferably arranged in the shaft wall of the material-free space 17 at the upper end of the cooling zone 22. The cooling gas flowing into the cooling zone 22 via the cooling gas inlet 23 preferably flows completely out of the cooling gas outlet 29 of the cooling air outlet device 17 out of the respective shaft 2.

A discharge device 41 is preferably arranged at the material-outlet-side end of each shaft 2. The discharge devices 41 comprise for example horizontal plates, preferably a discharge table, which allow the material to pass through laterally between the discharge table and the housing wall of the PFR shaft kiln. The discharge device 41 is preferably embodied as a push table or rotary table or as a table with push-type scraper means. This enables a uniform throughput speed of the material to be burned through the shafts 2. By way of example, the discharge device 41 also comprises the outlet funnel 25, which adjoins the discharge table and has the material outlet 40 attached at its lower end.

During operation of the PFR shaft kiln 1, one of the shafts 2 is active at any one time, with the respectively other shaft 2 being passive. The active shaft 2 is referred to as burning shaft and the passive shaft 2 is referred to as regenerative shaft. The PFR shaft kiln 1 is in particular operated in cycles, with a typical number of cycles being 75 to 150 cycles per day, for example. After the cycle time has expired, the function of the shafts 2 is swapped. This procedure is repeated continuously. Material such as limestone or dolomite rock is alternately fed into the shafts 2 via the material inlets 3. In the active shaft 2 operated as a burning shaft, a fuel is introduced into the burning shaft 2 via the burner lances 10. The material to be burned is heated in the preheating zone 21 of the burning shaft to a temperature of about 700 °C. In the exemplary embodiment of FIG. 1, the left-hand shaft 2 is operated as a burning shaft, while the right-hand shaft 2 is operated as a regenerative shaft.

During operation of the PFR shaft kiln 1, both in the burning shaft 2 and in the regenerative shaft 2, the cooling gas flows through the cooling zone 22 in countercurrent to the material to be cooled and is preferably completely discharged from the shaft 2 via the cooling gas outlet 29 so that preferably no cooling gas flows from the cooling zone 22 into the burning zone 20.

Inside the shaft 2 operated as a burning shaft, the combustion gas flows through the combustion gas inlet 12 into the burning shaft and in cocurrent with the material inside the burning zone 20 into the material-free space in the form of an annular channel 18.

From the material-free space 18, the gas flows via the connecting channel 19 into the shaft 2 operated as a regenerative shaft. Inside the regenerative shaft, the gas flows from the connecting channel 19 and the material-free space 18 of the regenerative shaft in countercurrent to the material to be burned through the burning zone 20 into the preheating zone 21 and leaves the regenerative shaft through the exhaust gas outlet 6 of the regenerative shaft. The exhaust gas discharged from the shaft 2 preferably has a temperature of 60 °C to 160 °C, preferably 100 °C.

The exhaust gas is conducted into an exhaust gas line 39 which adjoins the exhaust gas outlet 6. The exhaust gas line 39 optionally has, downstream of the exhaust gas outlet 6 in the direction of flow of the exhaust gas, an exhaust gas filter 31 for filtering fine particles, in particular dust, out of the exhaust gas. Downstream of the exhaust gas filter 31 the exhaust gas line 39 has a branching-off point, wherein part of the exhaust gas is conducted in a combustion gas line 4 to the combustion gas inlet 12. In the direction of flow of the exhaust gas, downstream of the branching-off point the combustion gas line 4 has by way of example a control element, such as a butterfly valve, and a compressor 35. The combustion gas line 4 is preferably connected to the combustion gas inlets 12 of the shafts 2, with the exhaust gas being fed preferably only to the combustion gas inlet 12 of the shaft 2 operated as a burning shaft via a control element connected upstream of the combustion gas inlet 12. The combustion gas line 4 is preferably connected to an oxidizing agent line 14 so that an oxidizing agent, preferably pure oxygen, is introduced into the combustion gas line 4 and then into the shaft 2 via the combustion gas inlet 12 together with the exhaust gas. It is also conceivable to introduce an oxygen-rich gas having a proportion of oxygen of at least 70% to 95%, preferably 90%, into the combustion gas line 4 as oxidizing agent.

The part of the exhaust gas not returned to the combustion gas inlet 12 is fed in the exhaust gas line 39 to a gas inlet 15 in the connecting channel 19. Downstream of the branching-off point of the combustion gas line 4 in the direction of flow of the exhaust gas, the exhaust gas line 39 preferably has an adjustable-volume compressor 36, a heat exchanger 43 and optionally a heating device 8 for heating the exhaust gas. By way of example, the heat exchanger 43 is in the form of a recuperator, wherein the exhaust gas is heated in countercurrent to the extracted cooling gas and the cooling gas is simultaneously cooled. In particular, the heat exchanger 43 is connected to the cooling gas outlets 29 of both shafts 2 via a cooling gas extraction line 11, so that the exhaust gas in the heat exchanger 43 is heated preferably in countercurrent by means of the extracted cooling gas. Downstream of the heat exchanger, the cooling gas extraction line 11 optionally has a control element for adjusting the amount of cooling gas to be extracted and a filter 16 for dedusting the cooling gas. The exhaust gas is preferably heated to a temperature of about 900 °C to 1100 °C, in particular 1000 °C, in the heat exchanger 43 and/or the heating device 8. It is also conceivable for the exhaust gas line 39 to have only a heat exchanger 43 or a heating device 8 for heating the exhaust gas. By way of example, the exhaust gas is heated to a temperature of about 600 °C in the heat exchanger 43 and then to a temperature of about 1000 °C in the heating device 8.

The heating device 8 is for example an electrically operated heating device. In particular, the heating device is operated by means of solar energy. It is also conceivable for the heating device 8 to comprise a heat exchanger, wherein the heating medium flowing in countercurrent is heated by solar energy. The heating device 8 is preferably in the form of a combustion reactor for the combustion of preferably renewable energy sources, such as wood, wherein the combustion is preferably performed in such a way that the combustion gas has a high proportion of CO₂ of at least 90%.

Part of the exhaust gas is branched off upstream of the heat exchanger 43 and discharged via a cooling device 32 by means of a compressor 37. Preferably, the entire amount of CO₂ from the calcination and the combustion, and the water from the combustion, are discharged from the PFR shaft kiln 1. The cooling device 32 is for example a heat exchanger which is preferably operated with a coolant, such as water, in countercurrent. By way of example, the exhaust gas line has a compressor 34, 36 in each case before and after the branching-off point of the exhaust gas to be discharged. The connecting channel 19 has a gas inlet 15 for admitting recirculated exhaust gas into the connecting channel 19. The gas inlet 15 is connected to the exhaust gas outlet 6 of the shaft 2 via the exhaust gas line 39 so that dedusted and heated exhaust gas discharged from the shaft 2 is conducted into the connecting channel 19. The gas inlet 15 is arranged by way of example centrally in the upper wall of the gas channel 15. It is also conceivable to arrange the gas inlet 15 at a position deviating therefrom in the wall of the connecting channel 19 or in the annular channels 18. It is also conceivable to install a multiplicity of gas inlets 15 in the connecting channel 19 or in the annular channels 18, each being connected to the exhaust gas line 39.

FIG. 1 further shows by way of example two gas analysis devices 45, 46. The gas analysis devices 45, 46 are configured such that they each determine the oxygen and/or CO₂ content of the respective gas. One gas analysis device 45 is arranged by way of example in the exhaust gas line 39 downstream of the branching-off point of the combustion gas line 4 and is configured to determine the oxygen and/or CO₂ content of the exhaust gas. In particular, the gas analysis device 45 is connected to a control device (not shown) for transmitting the determined oxygen and/or CO₂ content of the exhaust gas.

The oxidizing agent line 14 preferably has a control element, such as a valve or a flap, which can be used to adjust the amount of oxidizing agent in the combustion gas line 4. The control element is preferably connected to the control device, with the control device being configured in particular such that it controls the amount of oxidizing agent in the combustion gas line 4 depending on the oxygen and/or CO₂ content of the exhaust gas that is determined by means of the gas analysis device 45.

The control serves in particular for complete combustion of the fuel that is fed to the PFR shaft kiln 1 via the fuel line 9. An undesirably high proportion of oxygen in the exhaust gas line 39 is thus prevented. The CO₂ content is also measured in order to control the desired CO₂ content in the exhaust gas line 39.

The control device is preferably configured such that it compares the oxygen and/or CO₂ content determined by means of the gas analysis device 45 with a respective predetermined limit value or limit range and, in the event of a deviation of the determined value from the limit value or limit range, increases or reduces the amount of oxidizing agent in the combustion gas line.

The amount of oxidizing agent is preferably increased if the determined oxygen content is below the limit value or limit range. The amount of oxidizing agent is preferably reduced if the determined oxygen content is above the limit value or limit range.

One gas analysis device 46 is arranged by way of example in the cooling gas extraction line 11, in particular downstream of the heat exchanger 43 and for example the filter 16, and is configured to determine the oxygen and/or CO₂ content of the discharged cooling gas. In particular, the gas analysis device 46 is connected to the control device (not shown) for transmitting the determined oxygen and/or CO₂ content of the cooling gas.

The cooling gas extraction line 11 preferably has a control element, such as a valve or a flap, which can be used to adjust the amount of cooling gas to be discharged via the cooling gas extraction device 17. The control element is preferably connected to the control device, with the control device being configured in particular such that it controls the amount of cooling gas discharged via the cooling gas extraction device 17 depending on the oxygen and/or CO₂ content of the cooling gas that is determined by means of the gas analysis device 46.

The control serves in particular to remove the cooling gas from the PFR shaft kiln 1 as completely as possible while at the same time having as little CO₂ as possible or preferably no CO₂ in the cooling gas extraction line 11.

The control device is preferably configured such that it compares the oxygen and/or CO₂ content determined by means of the gas analysis device 46 with a respective predetermined limit value or limit range and, in the event of a deviation of the determined value from the limit value or limit range, increases or reduces the amount of cooling gas to be discharged via the cooling gas extraction device 17.

The amount of cooling gas is preferably increased if the determined CO₂ content is below the limit value or limit range. The amount of cooling gas is preferably reduced if the determined CO₂ content is above the limit value or limit range.

FIG. 2 shows a further exemplary embodiment of a PFR shaft kiln, said kiln largely corresponding to the PFR shaft kiln of FIG. 1. Identical elements are provided with identical reference signs. By way of example, in the PFR shaft kiln 1 of FIG. 2 the left-hand shaft 2 is operated as a burning shaft. In contrast to the PFR shaft kiln of FIG. 1, the PFR shaft kiln 1 of FIG. 2 has a cooling gas extraction device 17 comprising an inner cylinder 26 which extends from the cooling zone 22 at least partially into the burning zone 20 and has a cooling gas outlet 29 which is connected to the cooling gas extraction line 11.

The cooling zone 22 is formed by way of example in a shaft section which has an approximately constant cross section, the shaft cross section of the cooling zone 22 corresponding to the shaft cross section of the lower region of the burning zone 20. The material-free annular space of the PFR shaft kiln of FIG. 1 is therefore not formed in the exemplary embodiment of FIG. 2. Each shaft 2 of the PFR shaft kiln 1 of FIG. 2 has an inner cylinder 29 which extends centrally in the vertical direction through the cooling zone 22. By way of example, the inner cylinder 29 extends from the discharge device 41 through the cooling zone 22 into the burning zone 20 up to the height of the connecting channel 19. To cool the inner cylinder 29, a multiplicity of cooling air channels are formed in its outer walls and are connected to a cooling air line 7 for conducting cooling air. The cooling air is preferably conducted by means of a compressor 38 via the cooling air line 7 into the cooling air channels of the inner cylinder 26. By way of example, the heated cooling air is conducted into the cooling gas extraction line 11 and preferably fed into the heat exchanger 43 in order to heat the exhaust gas. The inner cylinders 26 each have a radially outwardly extending cooling air inlet 27 and a cooling air outlet 28 which are connected to the cooling air line 7.

The inner cylinder 26 of the cooling gas extraction device 17 has a cooling gas outlet 29 which extends radially outward from the inner cylinder 26 through the shaft wall and serves to conduct cooling gas from the inner cylinder into the cooling gas extraction line 11. The inner cylinder 26 also has a cooling gas inlet 30 for admitting cooling gas from the cooling zone 22 into the inner cylinder 26. The cooling gas inlet 30 extends through the inner cylinder wall into the cooling zone 22 and connects the interior of the inner cylinder 26 to the cooling zone 22. By way of example, each inner cylinder 26 has four cooling gas inlets 30 which are each formed at the same height in the inner cylinder wall and preferably extend at a uniform distance from one another in a star shape outward into the cooling zone 22. The cooling gas inlet 30 is preferably arranged above the cooling gas outlet 29 in the cooling zone 22. During operation of the PFR shaft kiln 1, the cooling gas flows from the bottom to the top through the cooling zone 22 and into the cooling gas inlet 30 into the inner cylinder 26 of the cooling gas extraction device 17. Preferably, all of the cooling gas introduced into the cooling zone 22 flows through the cooling gas inlets 30 into the cooling gas extraction device 17 so that no cooling gas passes into the burning zone 20. The cooling air outlet 29 of the inner cylinder 26 is preferably arranged in the lower region of the cooling zone 22. In particular, the cooling gas flows downward from the cooling gas inlet 30 in the inner cylinder 26 to the cooling gas outlet 29.

The conduction of the cooling gas extracted from the cooling zone 22 and that of the exhaust gas extracted from the preheating zone 21 correspond in the exemplary embodiment of FIG. 2 to the interconnection described with reference to FIG. 1.

FIG. 3 shows the timeline of one cycle V. Shown as dashed lines before the cycle V and after the cycle V are further cycles V. One cycle V lasts for, for example, 15 minutes. The cycle V is divided into a burning time W and a shaft switchover X. The burning time W is divided further into a fuel metering time Y, in which the fuel is introduced into the burning shaft, and a burnout time Z, in which no further fuel is introduced into the burning shaft, but an oxygen-containing gas continues to be supplied, so that the fuel still present in the burning shaft can burn out.

Now, FIG. 4 looks at the steps that take place during the shaft switchover X shown in FIG. 3. The aim here is to demonstrate the method according to the invention using a specific example. The shaft switchover X starts with the closing of the second exhaust gas outlet D that extends over 4 s in the example shown. Starting at the same time after 2 s are the opening of the second combustion gas inlet E, the closing of the first combustion gas inlet F and the opening of the first exhaust gas outlet G. The opening of the second combustion gas inlet E and the closing of the first combustion gas inlet F both take the same length of time and, just like the closing of the second exhaust gas outlet D, last 4 s. The opening of the first exhaust gas outlet G is slower and lasts 10 s in the example shown. Thereafter, the oxidizing agent supply H is started. The next cycle V starts with the start of the fuel supply I.

FIG. 5 shows the pressure curve at the upper end of the first shaft U, the pressure curve at the upper end of the second shaft S and the pressure curve in the connecting channel T in the course of the shaft switchover. Initially, the pressure in the first shaft operated as a burning shaft is higher, for example 1.3 bar. The pressure in the second shaft operated as a regenerative shaft is lower and is approximately 1 bar. The pressure in the connecting channel T is in between and is approximately 1.25 bar. The method according to the invention achieves the situation that the pressure in the first shaft falls at a rate v while, at the same time, the pressure in the second shaft rises at the rate v. It can be seen from the graph that a mathematically identical rate v is not meant here and that, instead, the rates v are identical within the scope of what is technically sensible and controllable. Constancy is not meant in the purely mathematical sense either, but within the scope of what is technically sensible. What can be clearly seen is that this is effected only in a first approximation within the scope of the technically customary pressure fluctuations and is not to be understood strictly mathematically. But apart from a very small dip in pressure in the connecting channel T when the pressure in the first shaft U and the pressure in the second shaft S intersect, the pressure in the connecting channel T remains constant, thus making it possible to substantially avoid mixing with the cooling air. At the end, the second shaft, which is now operated as a burning shaft, has the higher pressure of about 1.3 bar and the shaft now operated as a regenerative shaft has the lower pressure of about 1 bar.

### REFERENCE SIGNS

1 PFR shaft kiln
2 Shaft
3 Material inlet/lock
4 Combustion gas line
6 Exhaust gas outlet
7 Cooling air line
8 Heating device
9 Fuel line
10 Burner lances
11 Cooling gas extraction line
12 Combustion gas inlet
14 Oxidizing agent line
15 Gas inlet
16 Filter
17 Material-free space/cooling gas extraction device
18 Annular channel/material-free space
19 Connecting channel
20 Burning zone
21 Preheating zone
22 Cooling zone
23 Cooling gas inlet
25 Outlet funnel
26 Inner cylinder
27 Cooling air inlet
28 Cooling air outlet
29 Cooling gas outlet
30 Cooling gas inlet
31 Exhaust gas filter
32 Cooling device
33-38 Compressor
39 Exhaust gas line
40 Material outlet/lock
41 Discharge device
42a,b Connecting channels
43 Heat exchanger/recuperator
45, 46 Gas analysis device

1-19. (canceled)

20. A method for shaft switchover in a parallel flow regenerative shaft kiln, in which the shaft kiln is not depressurized during shaft switchover, wherein the parallel flow regenerative shaft kiln has a first shaft and a second shaft, wherein the first shaft has a first preheating zone for preheating the material, a first burning zone for burning the material and a first cooling zone for cooling the material, wherein the second shaft has a second preheating zone for preheating the material, a second burning zone for burning the material and a second cooling zone for cooling the material, wherein the first burning zone and the second burning zone are connected via a connecting channel, wherein the first preheating zone has a first combustion gas inlet and the second preheating zone has a second combustion gas inlet, wherein the first preheating zone has a first exhaust gas outlet and the second preheating zone has a second exhaust gas outlet, wherein the first burning zone has at least one first burning lance and the second burning zone has at least one second burning lance, wherein the at least one first burning lance is connected to a first fuel feed and the at least one second burning lance is connected to a second fuel feed, the method comprising the following steps:
a) operating the first shaft as a burning shaft and the second shaft as a regenerative shaft,
b) stopping the fuel supply through the first fuel feed and thus carrying out burnout in the first shaft,
c) closing the second exhaust gas outlet and, after the start of step c) and before the end of step c), starting the following steps d) to f),
d) opening the second combustion gas inlet,
e) closing the first combustion gas inlet,
f) opening the first exhaust gas outlet,
g) starting the fuel supply through the second fuel feed and thus operating the second shaft as a burning shaft and the first shaft as a regenerative shaft,
wherein steps d) and e) are carried out synchronously;
wherein step f) starts after the start and before the end of steps c), d) and e).

21. The method as claimed in claim 20, wherein steps c), d) and e) have a first length of time t₁, and step f) has a second time length of time t₂, the second length of time t₂ being longer than the first length of time t₁.

22. The method as claimed in claim 21, wherein the second length of time t₂ is 1.5 to 5 times as long as the first length of time t₁.

23. The method as claimed in claim 20, wherein step c) has a first length of time t₁, and steps d), e) and f) start ¼ t₁ to ¾ t₁ after the start of step c).

24. The method as claimed in claim 20, wherein the supply of cooling gas and the discharge of cooling gas in the first cooling zone and in the second cooling zone is continued continuously at a constant flow of cooling gas.

25. The method as claimed in claim 20, wherein the opening and closing in steps c), d), e) and f) is carried out at variable speed.

26. The method as claimed in claim 25, wherein a first pressure is measured in the upper gas region of the first shaft and a second pressure is measured in the upper gas region of the second shaft.

27. The method as claimed in claim 26, wherein the speed of opening and closing in closing in steps c), d), e) and f) is controlled such that the first pressure falls at a constant first rate and/or the second pressure rises at a constant second rate.

28. The method as claimed in claim 27, wherein the first rate is identical in terms of absolute value to the second rate, the first rate and the second rate having opposite signs.

29. The method as claimed in claim 20, wherein the first combustion gas inlet and the second combustion gas inlet are connected to a combustion gas line, the combustion gas line being connected to an oxidizing agent supply, the oxidizing agent supply being opened after completion of steps c), d), e) and f) and before the start of step g).

30. The method as claimed in claim 29, wherein the oxidizing agent supply is closed during step b).

31. The method as claimed in claim 30, wherein the closing of the oxidizing agent supply has been completed when step b) is ended.

32. The method as claimed in claim 20, wherein a rising opening speed is selected for the opening speed in steps d) and f).

33. The method as claimed in claim 20, wherein the feeding of reactant and the removal of product are carried out during step a).

34. The method as claimed in claim 20, wherein the opening position of the first combustion gas inlet, the second combustion gas inlet, the first exhaust gas outlet and the second exhaust gas outlet is detected.
